(19) United States
(12) Patent Application Publication
(10) Pub. No.: US 2006/0079131 A1
(43) Pub. Date: Apr. 13, 2006

(54) Card reading device

(76) Inventor: Sheng-Ching Ko, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/962,424

(22) Filed: Oct. 13, 2004

(51) Int. Cl. H01R 24/00

(52) U.S. Cl. 439/630

(57) ABSTRACT

A card reading device includes an insulating housing and at least one set of conductive terminals. The set of conductive terminals are mounted on the insulating housing by a locating member of the insulating housing. The card reading device has a simple configuration. Thereby, it is engaged more easily and production efficiency is improved.

### BACKGROUND OF THE INVENTION

1. Field of the Invention

The present invention relates to a card reading device, and particularly to a card reading device mounted on a Print Circuit Board (PCB) for retaining an electrical card so as to transmit data between the PCB and the electrical card introduced therein.

2. Description of Related Art

Recently, electrical cards have become widely used in the field of electronic appliances. As such, electrical card connectors are now adapted to connect electrical cards to appliances in which the electrical card connectors are mounted on the PCB of the appliance and retain electrical cards therein, allowing data to be transferred there between.

There currently exist many different kinds of electrical cards of different sizes. Thereby, many kinds of corresponding card reading devices have been created, such as a multi-in-one type card-reading device, in which many different kinds of electrical cards can be used. In these kinds of card reading devices, a plurality of corresponding sets of terminals are needed to electrically connect with the different electrical cards.

The conductive terminal set having conductive terminals mounted on the insulating housing are mainly inserted from a rear end of the insulating housing. The conductive terminals are arranged in an interferential manner.

However, in the assembly process, it takes many attempts to insert the conductive terminals, thus causing inefficiencies.

Moreover, because the conductive terminals are mounted on the insulating housing in an interferential manner, the conductive terminals cannot be located stably. After assembly, the conductive terminals are likely to be shaky and easily displaced. This configuration doesn't ensure that the electrical card is securely connected with the PCB, consequently stable data transmission cannot be guaranteed. Therefore, it is desirable to provide an improved card reading device for retaining electrical cards which overcomes the above-described disadvantage of the conventional card reading device.

### SUMMARY OF THE INVENTION

An objective of the present invention is to provide a card reading device, in which the conductive terminals are mounted on an insulating housing by being placed directly downwards, the card reading device has a simple assembly process, and production efficiency is improved.

Another object of the present invention is to provide a card reading device in which the conductive terminals are stable to ensure that the electrical card is securely connected with the card reading device, thus allowing data to be transmitted without any problems.

In order to achieve the above objectives, a card reading device in accordance with the present invention includes an insulating housing having a receiving cavity, and a locating member; at least one set of conductive terminals having a plurality of conductive terminals mounted on the insulating housing, each of the conductive terminals has a soldering portion extending out of the insulating housing, and a contact portion extending into the receiving cavity, the conductive terminals are located on the insulating housing by the locating member.

Other objects, advantages, and novel features of the present invention will became more apparent from the following detailed description when taken in conjunction with the accompanying drawings.

### BRIEF DESCRIPTION OF THE DRAWINGS

FIG. 1 is an exploded view of a card reading device according to the present invention.

FIG. 2 is an exploded view of an insulating housing, a first set of conductive terminals, and a first insulating plate of the card reading device of FIG. 1.

FIG. 3 is an assembled view of the insulating housing and the first set of conductive terminals of FIG. 2.

FIG. 4 is an assembled view of the insulating housing, the first set of conductive terminals, and the first insulating plate of FIG. 2.

FIG. 5 is an exploded view of the insulating housing, a second set of conductive terminals, and a second insulating plate of the card reading device of FIG. 1.

FIG. 6 is an assembled view of the insulating housing, the second set of conductive terminals, and the second insulating plate of FIG. 5.

### DETAILED DESCRIPTION OF PREFERRED EMBODIMENTS

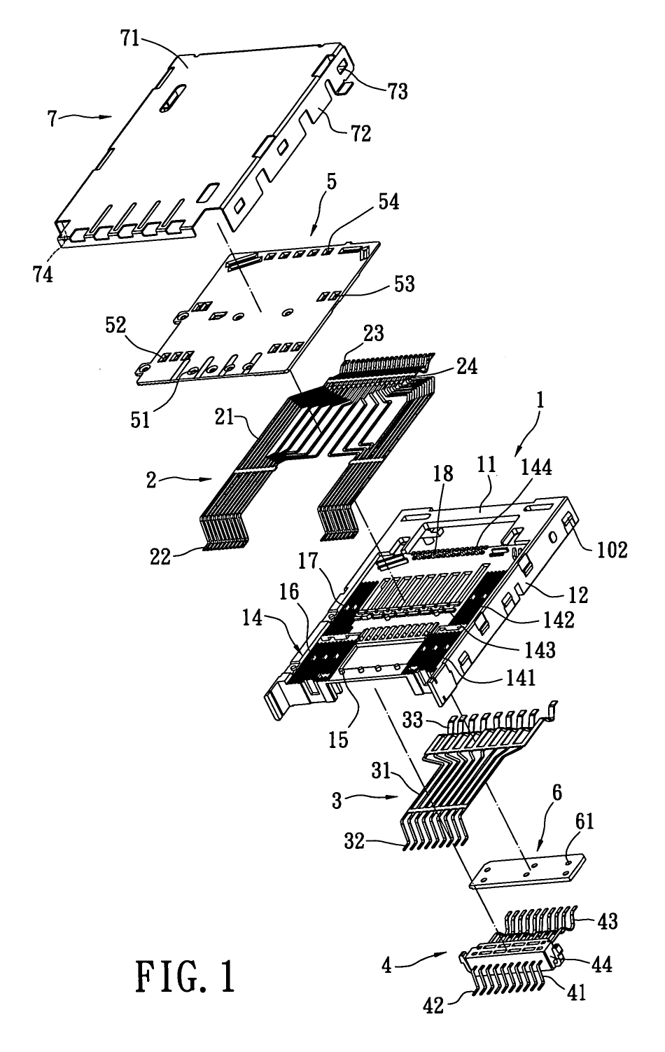

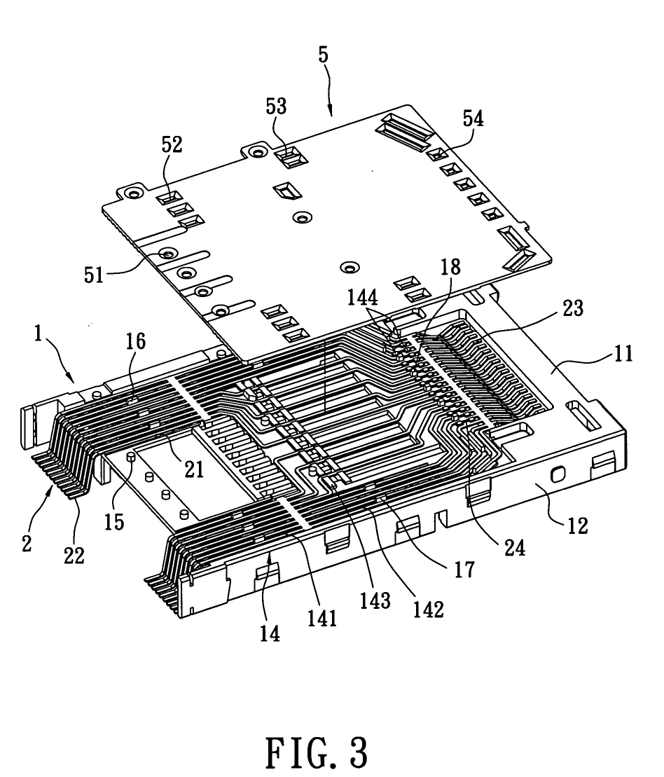

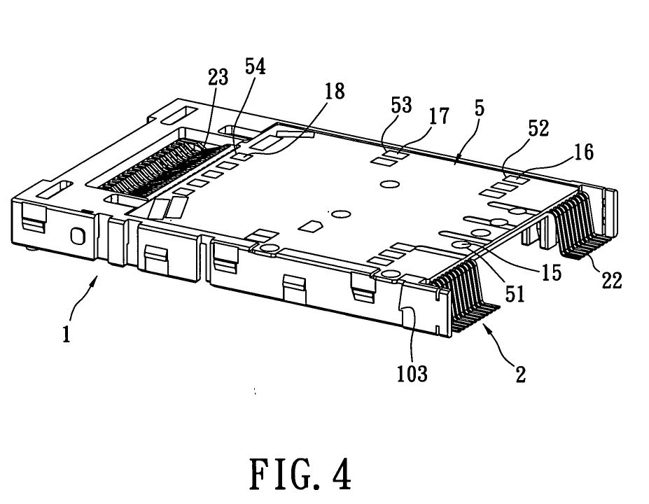

Referring to FIGS. 1-6, a card reading device in accordance with the present invention is shown. The card reading device comprises an insulating housing 1, a first set of conductive terminals 2, a second set of conductive terminals 3, a third set of conductive terminals 4, a first insulating plate 5, a second insulating plate 6, and a shielding cover 7. The insulating housing 1 is made of plastic material, which includes a base portion 11, and two arms 12 extending parallel from two ends of the base portion 11 respectively so as to form a receiving cavity 13 for inserting an electrical card.

The first, second, and third set of conductive terminals 2, 3 and 4 include a plurality of conductive terminals 21, 31, and 41, respectively. The conductive terminals 21, 31, and 41 are made of an elastic conductive metal material, which are alternately mounted on the base portion 11 of the insulating housing 1. Before mounting on the insulating housing 1, the conductive terminals 21 and 31 of the first and the second set of conductive terminals 2 and 3 are integrated with each other respectively. After being mounted on the insulating housing 1, the conductive terminals 21 and 31 are cut and separated so as to make the conductive terminals 21 and 31 alternately disposed on the insulating housing 1 respectively. The conductive terminals 41 of the set of conductive terminal 4 are pre-mounted on a fixing base 44, and then mated with the fixing base 44 with the insulating housing 1. The conductive terminals 21, 31 and 41 extend in an inserting or ejecting direction. Each of the conductive terminals 21, 31 and 41 have soldering portions 22, 32 and 42 extending out of a rear end of the insulating housing 1 respectively, which is made by bending each rear end of the conductive terminals 21, 31 and 41 for soldering and electrical connecting with a PCB. Each of the conductive terminals 21, 31 and 41 have contact portions 23, 33 and 43 extending into a front portion, a middle portion, and a rear portion of the receiving cavity 13 respectively. The receiving cavity 13 is made by bending one front end of each of the conductive terminals 21, 31 and 41 for electrical connecting with an inserted electrical card.

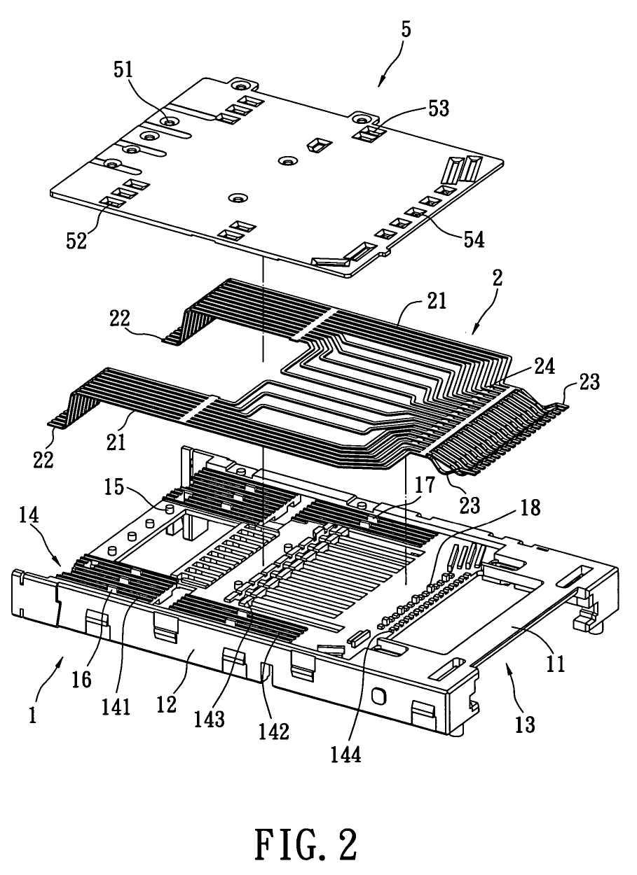

Referring to FIGS. 2-4, the plurality of conductive terminals 21 of the first set of conductive terminals 2 are mounted on a top surface of the base portion 11 of the insulating housing 1. The base portion 11 has a first locating member 14 disposed on the top surface thereof, and the first locating member 14 includes a plurality of locating bars 141, 142, and a plurality of locating tabs 143, 144. The locating bars 141, 142 extend lengthways. The locating bars 141, 142, and the locating tabs 143, 144 are disposed alternately on the base portion 11. The receiving cavity for retaining the conductive terminals 31 is formed between each two adjacent locating bars 141, 142 and locating tabs 143, 144 respectively.

The conductive terminals 21 are arranged between two adjacent locating bars 141, 142 or two adjacent locating tabs 143, 144 respectively. The conductive terminals 21 are separated and located by each of the locating bars 141, 142 or locating tabs 143, 144 to prevent the conductive terminals 21 from moving. Moreover, each of the conductive terminals 21 further includes a locating piece 24 disposed at a side of the contact port ion 23. The locating piece 24 is latched between two front-back adjacent locating tabs 144 for preventing the conductive terminals 21 from front-back moving. Thereby, the conductive terminals 21 are located stably on the base portion 11 of the insulating housing 1.

The first insulating plate 5 is made of a plastic material, which is disposed upon the insulating housing 1. The first insulating plate 5 has a plurality of fixing holes 51, 52, 53 and 54 therein. The shape, size and number of fixing holes 51, 52, 53 and 54 are unlimited. In this embodiment, the first insulating plate 5 is shaped as a planar plate, which has six locating holes 51 therein. The insulating housing 1 comprises fixing tabs 15, 16, 17 and 18 corresponding to the fixing holes 51, 52, 53 and 54, respectively, the fixing tabs 15, 16, 17 and 18 are received in corresponding fixing holes 51, 52, 53 and 54 so as to engage the first insulating plate 5 with the insulating housing 1. The first insulating plate 5 presses against the conductive terminals 21 to prevent the conductive terminals 21 from moving vertically thus fixing the conductive terminals 21 in the insulating housing 1.

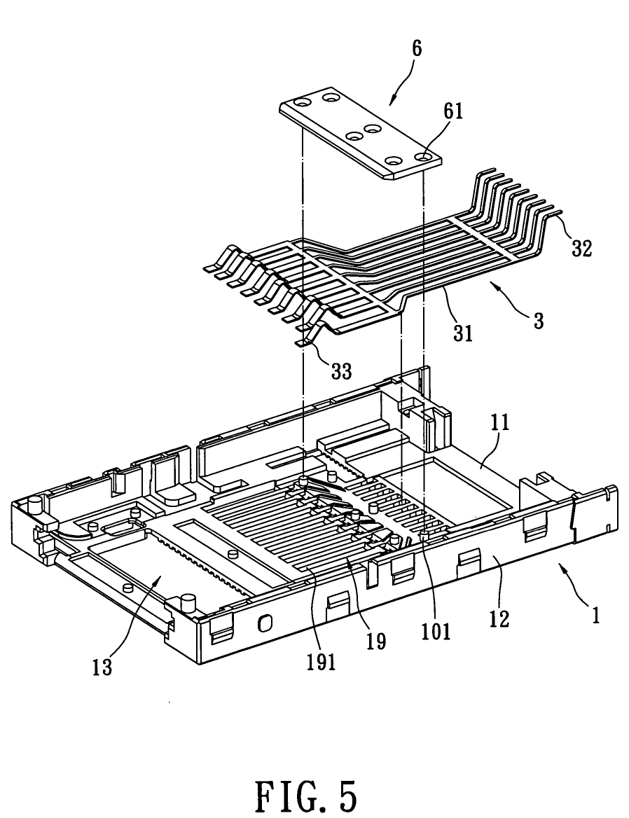

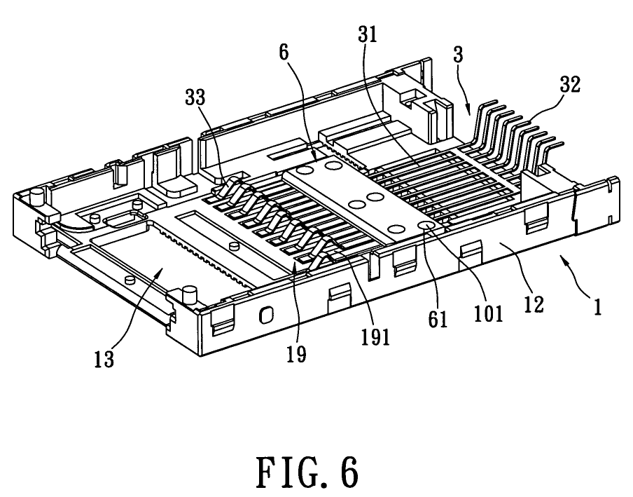

Referring to FIGS. 5-6, the conductive terminals 31 of the second set of conductive terminals 3 are mounted from below on a bottom surface of the base portion 11 of the insulating housing 1. The base portion 11 has a second locating member 19 disposed on the bottom surface thereof, and the second locating member 19 comprises a plurality of locating grooves 191 extending lengthways. The locating grooves 191 are alternately disposed on the base portions 191 and form a receiving cavity for retaining the conductive terminals 31.

The conductive terminals 31 are received in corresponding locating grooves 191. Each of the conductive terminals 31 are separated and located by each of the locating grooves 191 to prevent the conductive terminals from moving.

The second insulating plate 6 is made of a plastic material, which is disposed below the insulating housing 1. The second insulating plate 6 has a plurality of fixing holes 61 therein. The insulating housing 1 comprises a plurality of corresponding fixing tabs 101 for mating with the fixing holes 61. The fixing tab 101 can mate with the corresponding fixing holes 61 by fixing, riveting, curing or the like thus fixing the second insulating plate 6 to the insulating housing 1. The second insulating plate 6 presses against the conductive terminals 31 to prevent the conductive terminals 31 from moving vertically thus fixing the conductive terminals 31 in the insulating housing 1.

The shielding cover 7 is made of a metal material, which is mounted on the insulating plate 5 to prevent Electro Magnetic Interference (EMI). The shielding cover 7 includes a top wall 71, and two side walls 72 extending downwards from the edges of two sides of the top wall 71. Each of the side walls 72 has a plurality of latching holes 73 therein. The arms 12 of insulating housing 1 include a plurality of latching tabs 102 disposed on the outside thereof and corresponding to the latching holes 73. The latching tabs 102 latch on to the latching holes 73 for combining the shielding cover 7 and the insulating housing 1. Moreover, the shielding cover 7 further comprises at least one latching piece 74 disposed at one side thereof. The insulating housing 1 comprises a corresponding latching piece 103 for latching the latching piece 74 so as to securely combine the shielding cover and the insulating housing 1.

When inserting an electrical card, the electrical card is pressed into the receiving cavity from above. The electrical conductive portions of the electrical card connected electrical to the contact portions 23, 33 and 43 of the conductive terminals 21, 31 and 41 to make the electrical card connect electrically to the PCB. Conversely, the ejector (not shown) releases the electrical card.

According to the foregoing description, compared with the conventional card reading device, the card reading device according to the present invention has the following advantages.

First, the conductive terminals 21 and 31 are mounted on the insulating housing 1 respectively. The assembling process is simpler, and, as such production efficiency is improved.

Second, the latching members 14, 19 are disposed between the insulating housing 1 and the conductive terminals 21, 31, while the insulating plate 5, 6 also presses against the conductive terminals 21, 31 respectively. Thereby, the conductive terminals are secured. This configuration ensures that the conductive terminals are electrically connected securely to the electrical card, and that data is transmitted stably.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A card reading device comprising:
an insulating housing having a receiving cavity, and a locating member;
at least one set of conductive terminals having a plurality of conductive terminals mounted on the insulating housing, each of the conductive terminals has a soldering portion extending out of the insulating housing, and a contact portion extending into the receiving cavity, the conductive terminals are located on the insulating housing by the locating member.

2. The card reading device as claimed in claim 1, wherein the insulating housing further comprises a base portion, and two arms extending parallel from two ends of the base portion respectively so as to form the receiving cavity.

3. The card reading device as claimed in claim 1, wherein the locating member comprises a plurality of locating bars and a plurality of locating tabs, the conductive terminals are disposed between two adjacent locating bars and each two adjacent locating tabs respectively.

4. The card reading device as claimed in claim 3, wherein each of the conductive terminals comprises a locating piece projected from one side thereof, and each of the locating pieces are latched between two adjacent locating tabs.

5. The card reading device as claimed in claim 1, wherein the locating member comprises a plurality of locating grooves for receiving the conductive terminals therein.

6. The card reading device as claimed in claim 1, wherein the conductive terminals of the set of conductive terminals are placed on the insulting housing.

7. The card reading device as claimed in claim 1, wherein the conductive terminals of the set of conductive terminals are placed on the insulting housing.

8. The card reading device as claimed in claim 1, further comprising an insulating plate, the insulating plate mounted on the insulating housing and pressed against the conductive terminals.

9. The card reading device as claimed in claim 8, wherein the insulating plate further comprises a plurality of locating holes, the insulating housing further comprising a plurality of locating bars, the locating bars engaged in corresponding locating holes for mating the insulating plate with the insulating housing.

10. The card reading device as claimed in claim 8, further comprising a shielding cover having a top wall and two side walls, the shielding cover mounted on the insulating housing.

11. The card reading device as claimed in claim 10, wherein each of the side walls comprises a plurality of latching holes respectively, the insulating housing comprising a plurality of latching tabs disposed at outside thereof, the latching tabs fixed into the corresponding latching holes for assembling the shielding cover and the insulating housing.

12. The card reading device as claimed in claim 10, wherein the shielding cover comprises at least one latching piece disposed at one side thereof, the insulating housing having a corresponding latching piece for mating with the latching piece of the shielding cover.
